(19) United States
(12) Patent Application Publication
(10) Pub. No.: US 2021/0047203 A1
(43) Pub. Date: Feb. 18, 2021

(54) METHOD AND DEVICE FOR CONTINUOUS SALT EXTRACTION FROM BRINE

(71) Applicant: KING ABDULLAH UNIVERSITY OF SCIENCE AND TECHNOLOGY, Thuwal (SA)

(72) Inventors: Peng WANG, Thuwal (SA); Yifeng SHI, Thuwal (SA); Chenlin ZHANG, Thuwal (SA)

(21) Appl. No.: 16/976,418

(22) PCT Filed: Feb. 25, 2019
(86) PCT No.: PCT/IB2019/051508

§ 371 Date: Aug. 27, 2020

Related U.S. Application Data
(60) Provisional application No. 62/639,147, filed on Mar. 6, 2018.

(51) Int. Cl. C02F 1/04; C02F 1/08; C02F 1/14; C02F 1/00; B01D 1/00; B01D 1/24; B01D 9/00; C01D 3/06

(52) U.S. Cl. CPC C02F 1/042; C02F 1/08; C02F 1/14; C02F 1/008; B01D 1/0035; C02F 2101/12; B01D 9/0031; B01D 9/005; B01D 9/0063; C01D 3/06; B01D 1/24

(57) ABSTRACT

A water evaporation system includes an evaporation module configured to evaporate water from a brine; a support module attached to the evaporation module and configured to support the evaporation module above the brine; and an inlet configured to add a crystal growth inhibitor to the brine.

### CROSS-REFERENCE TO RELATED APPLICATIONS

This application claims priority to U.S. Provisional Patent Application No. 62/639,147, filed on Mar. 6, 2018, entitled “METHOD AND DEVICES FOR CONTINUOUS SALT EXTRACTION FROM BRINE,” the disclosure of which is incorporated herein by reference in its entirety.

### BACKGROUND

### Technical Field

Embodiments of the subject matter disclosed herein generally relate to methods and devices for water evaporation, and more specifically, to processes and systems for enhancing water evaporation from salty aqueous solutions while reducing hard salt deposits formed on the evaporation equipment.

### Discussion of the Background

To meet the increasing demand of clean water, a series of seawater desalination technologies, such as low-temperature multi-effect distillation (LT-MED), multi-stage flash (MSF), reverse osmosis (RO), membrane distillation (MD), etc., have been widely used around the world. These desalination processes produce large quantities of very salty water, known as brine. Besides, many industrial processes, such as oil extraction, shale gas exploration, coal mining, and flue gas desulfurization, generate large quantities of highly concentrated brine or hypersaline water. Proper disposal of these brine waters has become a big problem as their direct discharge inland or in sea would cause soil and groundwater salinization and adversely impact the health of marine life. In many places of the world, direct disposal of brine underground, into municipal sewer, or in sea has been banned. Thus, there is a need for energy efficient brine treatment technologies. A proper brine treatment technology is supposed to not only minimize the environment risk, but also to recover valuable salts.

The large osmotic pressure of the highly concentrated brine would make conventional RO systems an unsuitable option. In practice, the concentrated brine is typically treated by a brine crystallizer or an evaporation pond. However, high energy consumption and frequent scaling and fouling inside the crystallizer makes the crystallization process expensive and inefficient. The salt fouling and scaling in the brine crystallizer is induced by the complex composition of the saturated brine. The salt fouling reduces the heat exchange efficiency and increases the energy consumption. On the other hand, the evaporation pond faces the concerns of salt water leakage, low energy efficiency, and large land area requirement.

The idea of interfacial evaporation and crystallization is one of the promising methods for brine treatment. In the last decade, interfacial evaporation utilizing solar energy has raised a lot of attention. Unlike the traditional evaporation process, the interfacial evaporation avoids heating bulk water body, reduces heat loss and ensures a higher energy efficiency.

However, the salt crystallization process in interfacial evaporation systems faces its own problems. In the existing solar-driven interfacial heating systems for brine treatment, the formed salt crystals have to be removed manually to ensure the sustained efficiency of the system. It is expected that the salt fouling and scaling in these interfacial evaporation systems are as problematic as in the bulk water evaporation. Thus, an interfacial evaporation system with well controlled salt crystallization to minimize salt fouling and scaling is highly desired.

### SUMMARY

According to an embodiment, there is a water evaporation system that includes an evaporation module configured to evaporate water from a brine, a support module attached to the evaporation module and configured to support the evaporation module above the brine, and an inlet configured to add a crystal growth inhibitor to the brine.

According to another embodiment, there is a method for evaporating water from a brine. The method includes mixing the brine with a crystal growth inhibitor to have a given ratio, providing the mixed brine and the crystal growth inhibitor to an evaporation module, adding heat to the evaporation module to evaporate water from the mixed brine and the crystal growth inhibitor, and collecting salt crystals from the evaporation module as the water is continuously evaporated. The salt crystals have a modified structure in which ions of the salt crystals were replaced by ions of the crystal growth inhibitor.

According to yet another embodiment, there is a water evaporation system that includes a heat source layer configured to receive solar energy, a brine evaporation interface layer configured to receive a mixture of a brine and a crystal growth inhibitor from which to evaporate water, and a barrier layer located between the heat source layer and the brine evaporation interface layer so that no salt from the brine contaminates the heat source layer.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a water evaporation system that uses a mixture of a brine and a crystal growth inhibitor to prevent salt hardening on an evaporation module;

FIGS. 2A to 2F illustrate various shapes of the evaporation module of the water evaporation system;

FIG. 3 illustrates a water evaporation system that uses a hot fluid for generating heat for water evaporation;

FIG. 4 illustrates a water evaporation system that uses a Joule heater for generating heat for water evaporation;

FIG. 5 illustrates a water evaporation system that uses a combustion chamber for generating heat for water evaporation;

FIG. 6 illustrates a water evaporation system that uses solar energy for generating heat for water evaporation;

FIG. 7 illustrates a water evaporation system that uses solar energy for generating heat for water evaporation and has an inclined evaporation module;

FIGS. 8A and 8B illustrate a crystallizer system for evaporating water from a brine;

FIG. 9 illustrates another crystallizer system for evaporating water from a brine;

FIG. 10 illustrates the mass change due to the water evaporation for a system that uses pure water and a system that uses a brine; and

FIG. 11 is a flow chart of a method for evaporating water with one of the systems noted above.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a water evaporation system that is used to evaporate water from a brine. However, the invention is not limited to this scenario, but it may be used to evaporate water from an aqueous solution.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel water evaporation system is configured to continuously crystallize salt at an air/brine interface. The novel system adds a given amount of crystal growth inhibitor into the feed brine, which leads to the formation of salt crystals with a very loose structure. The loosely grown/packed salt crystals can be easily removed from the air-brine interface of the system, sometimes even by the action of gravity.

This new system offers a solution to the long-standing problem of brine treatment and salt resource recovery in many industrial processes. The embodiments to be discussed next offer a variety of options to suit varying application purposes, including desalination with zero-liquid discharge, salt recovery from wastewater, salt mineral extraction from salt lakes, brine treatment for all kind of water plants, etc.

To achieve these advantages, the addition of the crystal growth inhibitor into the brine keeps the crystallization process to continuously occur at the interface of air and brine. Under regular circumstances, salt crystalizes at the air/brine interface and forms a very tightly packed cake layer on the substrate surface, which is very hard to remove once formed. Taking the sodium chloride crystal as an example, the regular NaCl crystals have large cubic shapes and sharp edges and cement together as very hard solids.

In comparison, with the crystal growth inhibitor present in the feed brine, the ions from the inhibitor partially replace the chloride ions in the sodium chloride crystals and thus keep them from forming cemented crusts. This condition allows for the NaCl to form feather-like crystals instead of cubic ones, which leads to a non-dense salt layer of soft efflorescence. Such a layer of salt efflorescence can be removed easily and can even be automatically cleaned off from the surface of the evaporator by gravity. Therefore, adding crystal growth inhibitor into the brine ensures the continuously crystallization process.

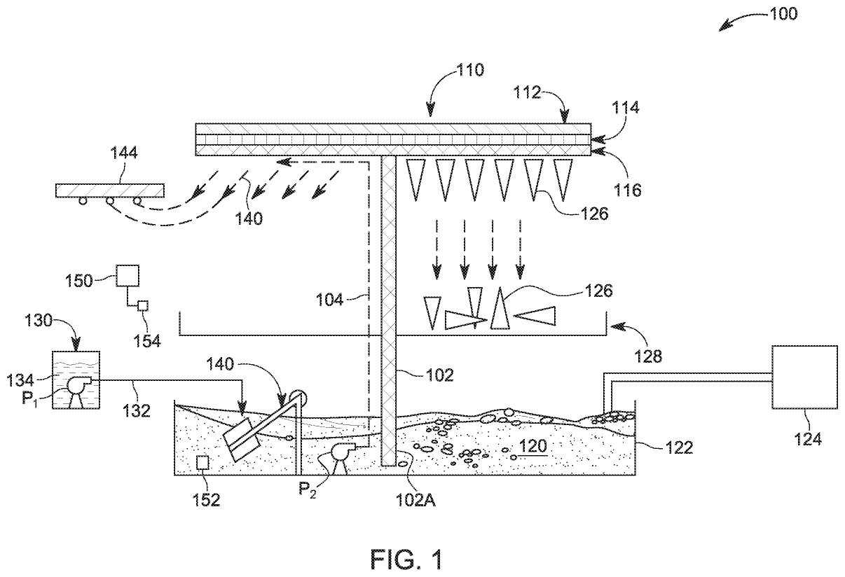

According to an embodiment illustrated in FIG. 1, the novel continuous water evaporation system 100 has a mushroom or T-shaped structure. System 100 includes a support module 102 and an evaporation module 110, which is physically supported by the support module 102. In one implementation, the evaporation module 110 has a three-layered structure. More specifically, the evaporation module 110 includes a top layer 112, which is an insulation layer for reducing the heat loss into the ambient environment. The evaporation module further includes a middle layer 114 that is the heat source layer and this layer supplies the heat to drive the brine evaporation. The evaporation module also includes a bottom layer 116, which is a porous layer configured to provide the brine evaporation interface.

In one application, the three layers are in contact with each other as illustrated in FIG. 1. The insulation layer 112 may be facing away from the brine. The brine evaporation interface layer is opposite from the insulation layer 112, and it is preferably facing the brine. The heat source layer 114 is sandwiched between the insulation layer 112 and the brine evaporation interface layer 116. In one application, the brine evaporation interface layer 116 is configured to directly face the brine pool.

The brine 120 may be located in a brine container 122. In one application, the brine container 122 is constantly supplied with brine 120 from an exterior source 124. The exterior source 124 may be a plant that generates the brine, the ocean, a salt removal plant, or any industrial facility that generates brines. A crystal growth inhibitor source 130 (for example a container) is fluidly connected through an inlet (conduit) 132 to the brine container 122. The crystal growth inhibitor 134 may be pumped, with a pump P1, in a continuous or intermittent manner from the crystal growth inhibitor source 130 into the brine container 122. An optional stirring device 140 may stir the crystal growth inhibitor 130 with the brine 120 for achieving a uniform chemical composition. A controller 150 may be used to control the actuation of the stirring device 140 based on, for example, readings from a concentration sensor 152 and/or a temperature sensor 154.

The support module 102 may be physically attached with a bottom end 102A to the brine container 122 and with a top end 102A to the evaporation module 110. In this way, a brine supply path 104 is directly established between the brine 120 from the brine container 122 and the brine evaporation interface layer 116, to provide a continuous brine supply. The brine supply path 104 can be implemented as (1) a mechanical water pump P2 that pumps the brine through a pipe to the brine evaporation interface layer 116, (2) a hydrophilic porous material that promotes a strong capillarity force that takes the brine to the brine evaporation interface layer 116, or a combination of both (1) and (2).

The heat transfer mechanism between the heat source layer 114 and the brine 120 for the system 100 is now discussed. The heat is being supplied to the heat source layer 114 by various means, as will be discussed later. Then, the heat from the heat source layer 114 is transferred to the brine evaporation interface layer 116 due to the direct contact between these two layers, to accelerate the brine water evaporation. Note that the insulation layer 112 being disposed on the external face of the heat source layer 114, prevents the heat from the heat source layer 114 to being wasted to the ambient. With the crystal growth inhibitor 134 mixed up into the brine 120, the salt 126 loosely crystalizes on the brine evaporation interface layer 116 and precipitates on the surface of this layer, as shown in FIG. 1.

The loosely packed salt crystals 126 can be removed manually or passively and automatically by gravity and collected by a salt collection tank 128, located underneath the brine evaporation interface layer. Preliminary results have shown that for the system 100, the salt is loosely accumulated on the brine evaporation interface layer 116 and thus, does not significantly affect the evaporation rate therein in this layer.

The water vapors 140 in FIG. 1, which evaporate from the brine evaporation interface layer, are simply released into the atmosphere. However, in one embodiment, it is possible to have a water collection system 144 on which the water vapors 140 condensate. The water collection system 144 may also be configured to collect the condensate. For example, the water collection system 144 may be a housing provided around the evaporation module 110.

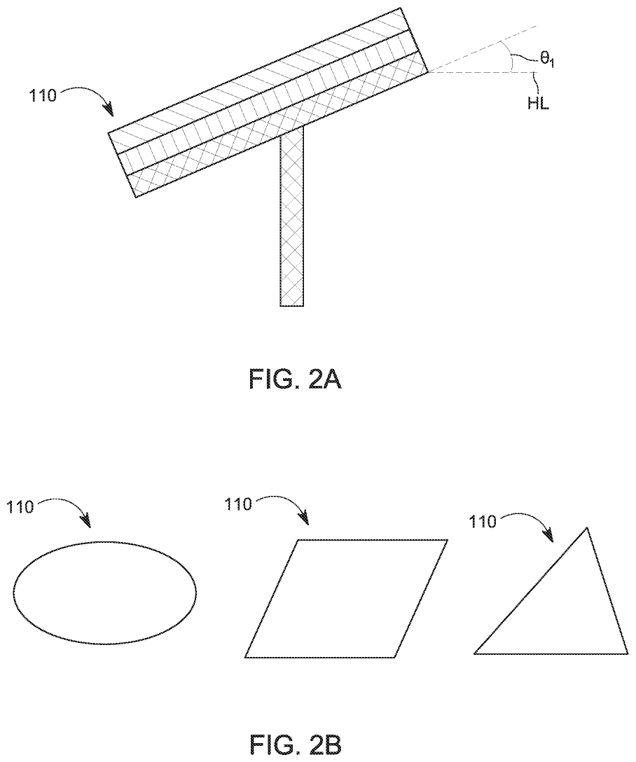

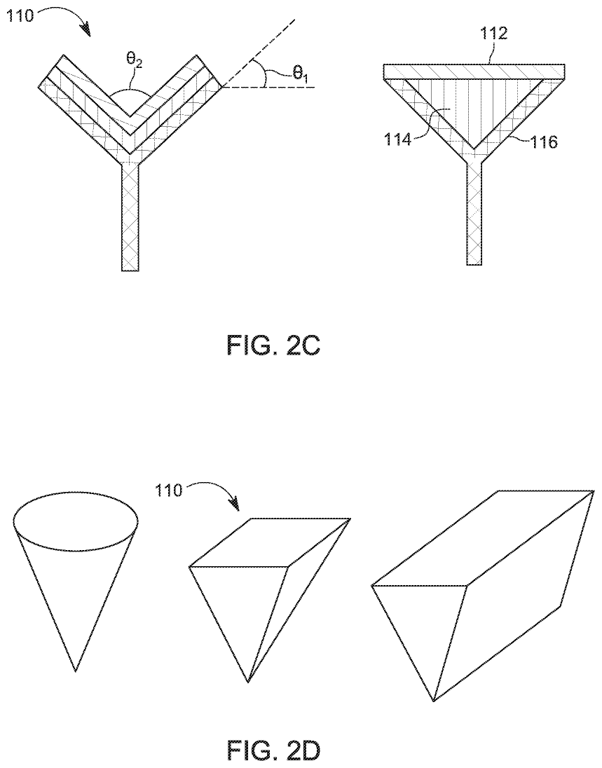

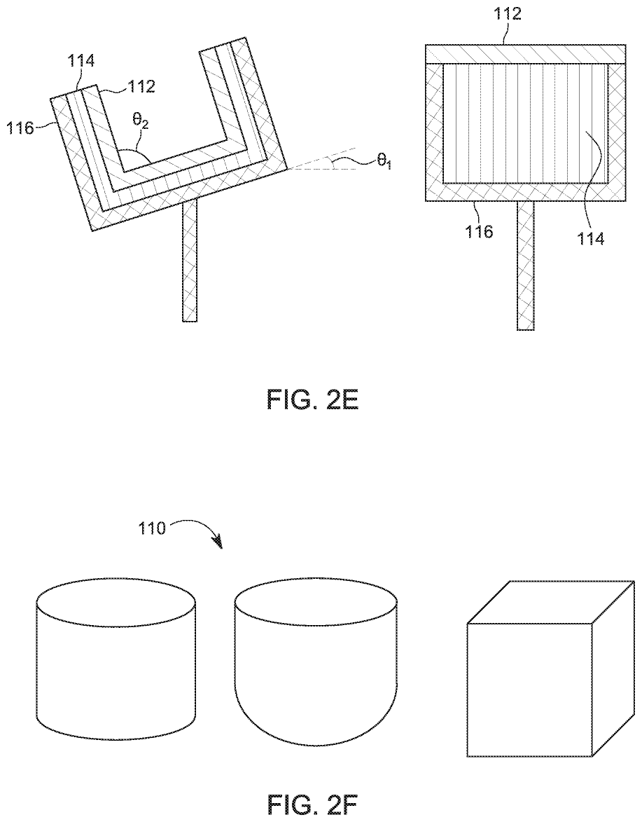

While the continuous water evaporation system 100 of FIG. 1 uses a T-shaped evaporation module 110, it is possible to use other shapes for this module. In this regard, FIGS. 2A-2F show various possible cross-sections of the evaporation module. More specifically, FIG. 2A shows a flat evaporation module that extends along a straight line that makes an angle θ with a horizontal line HL. FIG. 2B illustrates a bird view of the possible evaporation modules 110. FIG. 2C shows the evaporation module 110 having a V-shape, where the two arms of the V-shaped module make an angle θ₂ with each other and each arm makes an angle θ₁ with a horizontal line. The angles can range from zero to 180 degrees. While the three layers 112, 114, and 116 may be provided for the V-shaped module in the order illustrated in FIG. 1, it is also possible that only the brine evaporation interface layer 116 has the V-shape, the heat source layer 114 fills the V-shaped profile, and the insulation layer 112 is flat and covers the entire V-shape region as illustrated in FIG. 2C. FIG. 2D shows the possible 3D shapes of the evaporation module 110. FIG. 2E shows another cross-section of the evaporation module 110. In this embodiment, the evaporation module 110 has a cup-like shape, with the interior of the cup being empty, or filed with by the heat source layer 114. The 3D shape of the evaporation module is shown in FIG. 2F, and it may be a cylinder, cube, parallelepiped or part of a cylinder.

The heat source layer 114, as previously discussed, has the purpose of providing the necessary heat to the brine evaporation interface layer 116, to evaporate the water from the brine. The insulating layer 112 has the purpose of preventing the heat from the heat source layer 114 from dissipating into the ambient environment. The insulating layer 112 may include one or more of a vacuum chamber, porous or nonporous materials with low thermal conductivity to reduce heat conduction, a nonporous transparent layer to reduce convection heat loss, etc. The brine evaporation interface layer 116 may include any material that promotes capillarity so that the brine 120 gets distributed over the entire layer.

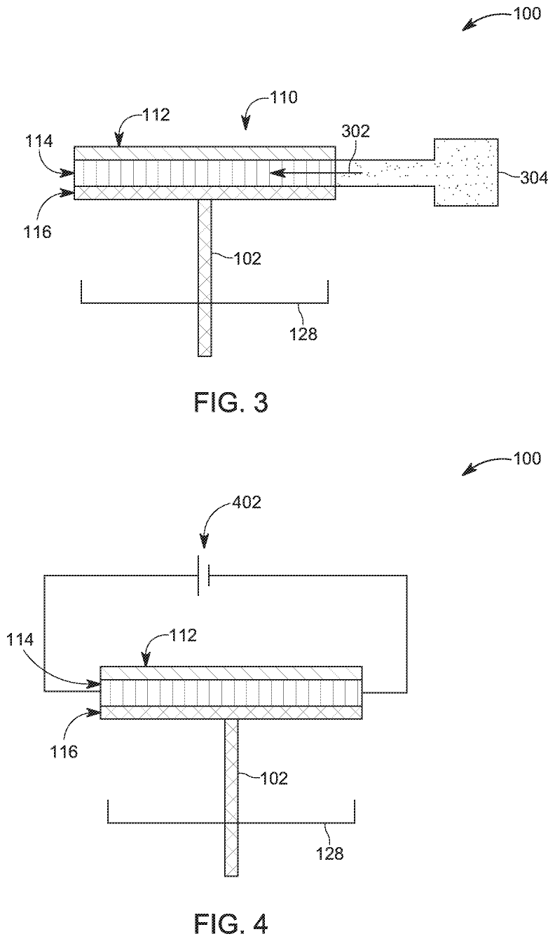

The continuous water evaporation system 100 of FIG. 1 may be implemented in a practical application in various ways, a couple of which are now discussed. FIG. 3 shows the system 100 having the heat source layer 114 implemented as a conduit through which a high temperature fluid 302 flows. The high temperature fluid 302 may be high temperature water, silicone oil, steam, etc. obtained, for example, from a high temperature fluid source 304, which may be a power plant, or any other industrial utility that generates these high temperature fluids as a byproduct. In one embodiment, the high temperature fluid source 304 is a household device, a solar cell, a wind turbine, an electric motor, etc.

The embodiment illustrated in FIG. 4 shows the heat source layer 114 being a Joule heater powered by an electric power source 402, which may be any device capable of generating electricity. This means that for this embodiment no fluid flows through the heat source layer 114. A Joule heater may be implemented in many ways, one of which is an electrical resistance that generates heat when connected to an electrical current.

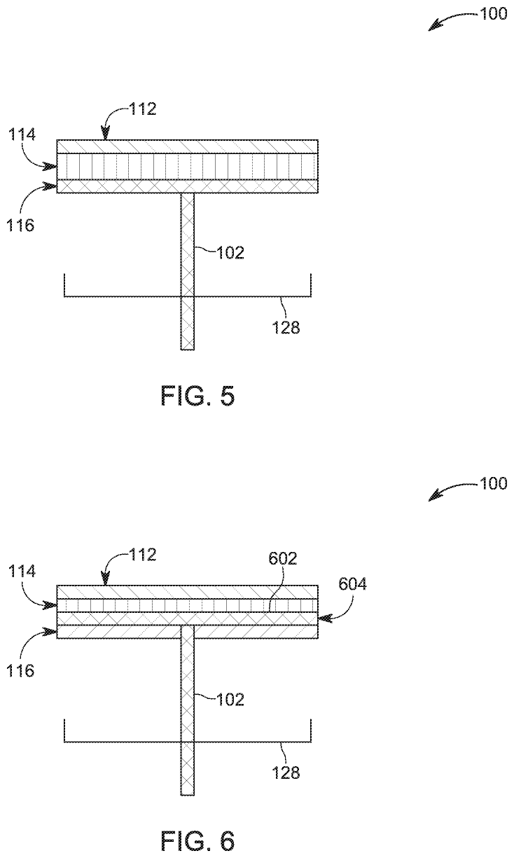

The embodiment illustrated in FIG. 5 implements the heat source layer 114 as a combustion chamber. The fuel (such as gasoline, biomass, coal, etc.) burns inside the chamber and supplies the heat to drive the evaporation on the brine evaporation interface layer 116.

The embodiment illustrated in FIG. 6 uses a photothermal material 602 as the heat source layer and acts as a heat resource because it can capture sunlight and convert the sunlight into heat energy directly. The photothermal material can be either porous or nonporous. If the photothermal material is porous, an optional separation layer 604 can be added between the heat source layer 114 and the brine evaporation interface layer 116, to prevent the brine from wetting the heat source layer 114. In one application, the insulation layer 112 can be removed.

The photothermal material 602 in the embodiment of FIG. 6 may have a wide adsorption within the solar spectrum. For example, the photothermal material may include metal nanoparticle (gold, silver, copper, cobalt, iron, nickel, aluminum, and there alloys), dark metal oxides (Co3O4, MnO2, Ti2O3, Fe3O4, CuCr2O4, FeCr2O4, CuMn2O4, MnFe2O4, ZnFe2O4, MgFe2O4, etc.), dark metal chalcogenides (MoS2, MoSe2, WSe2, CdS, CdTe, etc.), carbon based materials (carbon black, carbon nanotubes, graphene, graphene oxide, reduced graphene oxide, carbon dots, etc.), all kinds of black paint and black cement materials, all kinds of black polymer materials, and composite materials made of one or more of the materials mentioned above.

An anti-reflective coating can be coated on the surface of the photothermal material in order to increase the absorption of solar light. The anti-reflective coating may include: transparent metal fluoride film (calcium fluoride, magnesium fluoride, etc.), transparent metal oxide film (titanium oxide, zinc oxide, etc.), transparent semiconductor film (silica, lead selenide, etc.), and transparent selenium sulfide film.

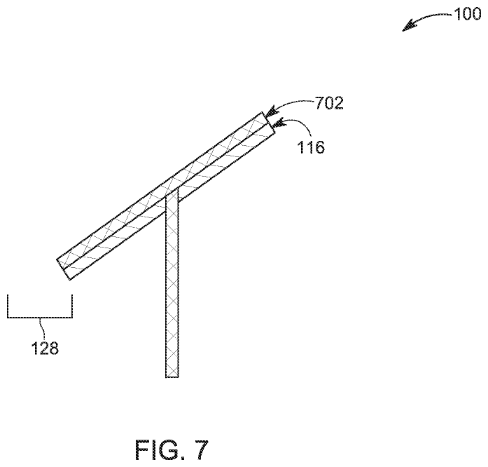

In the embodiment illustrated in FIG. 7, the heat source layer 114 and the insulation layer 112 are combined into a single layer 702. The combined layer 702 may be porous and acts as the photothermal layer and water evaporation layer at the same time. The layer 702 in FIG. 7 is inclined relative to the horizontal by a non-zero angle.

The embodiments illustrated in FIGS. 3 to 7 omit the brine container 122 that holds the brine 120 and the crystal growth inhibitor 134 (and also the source 130 of the crystal growth inhibitor and the optional stirring device 140). However, the brine 120 and the crystal growth inhibitor 134 are present in each embodiment and they may be supplied from the brine container 122 or through other means, for example, being sprayed directly on the support module 102 and/or the evaporation module 110.

The crystal growth inhibitor used in these embodiments may include one or more of ferricyanide (potassium ferrocyanide, sodium ferrocyanide, etc.), nitrilotriacetic acid and its derivatives (2,2′,2″-nitrilotris(acetamide), Nitrilotriacetic acid trisodium, etc.), trimethyl phosphate and its derivatives (penta-phosphate, diethylenetriaminepentakis methylphosphonic acid, etc.), citric acid and its derivatives (potassium citrate, sodium citrate, etc.), ethylenediaminetetraacetic acid and its derivatives (dipotassium edetate, disodium edetate, etc.), tartaric acid and its derivatives (iron(III) meso-tartaric acid, sodium tartrate, etc.) and cadmium chloride. The amount of crystal growth inhibitor added to the brine may range from 0.00001% to 15.0% of the volume of the brine in the brine container 122. In one application, the controller 150 (e.g., a processor) may be used to measure (with an appropriate sensor 152 placed in the brine container 120) the concentration of the crystal growth inhibitor 134 and to stop or start pump P1 to adjust this concentration based on a target concentration. In one embodiment, the present concentration may change as a function of the ambient temperature, which can be measured with a temperature sensor 154.

During the process of salt extraction, the system 100 can be physically located away from the brine container 122 as long as the brine path 104 is capable of continuously delivering the brine 120 to the evaporation surfaces of the brine evaporation interface layer 116. The brine evaporation material of the brine evaporation interface layer 116 may be porous and hydrophilic and can include one or more of paper, quartz glass fibrous membrane, carbon paper, copper foam, carbon foam, polymer foam, macroporous silica, etc. The hydrophilic porous material of the brine evaporation interface layer 116 can be further modified to be super-hydrophilic and with special nanostructure which allows ultrafast water transport inside. This would further improve the long-term operation performance of the system 100.

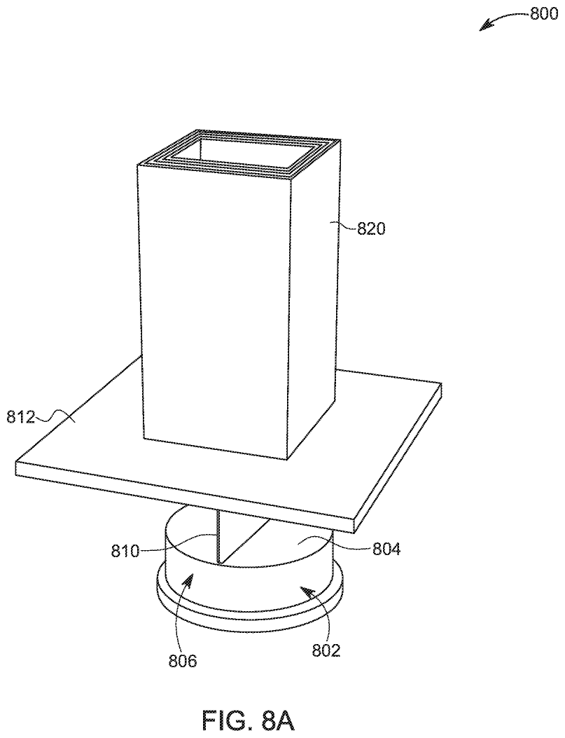

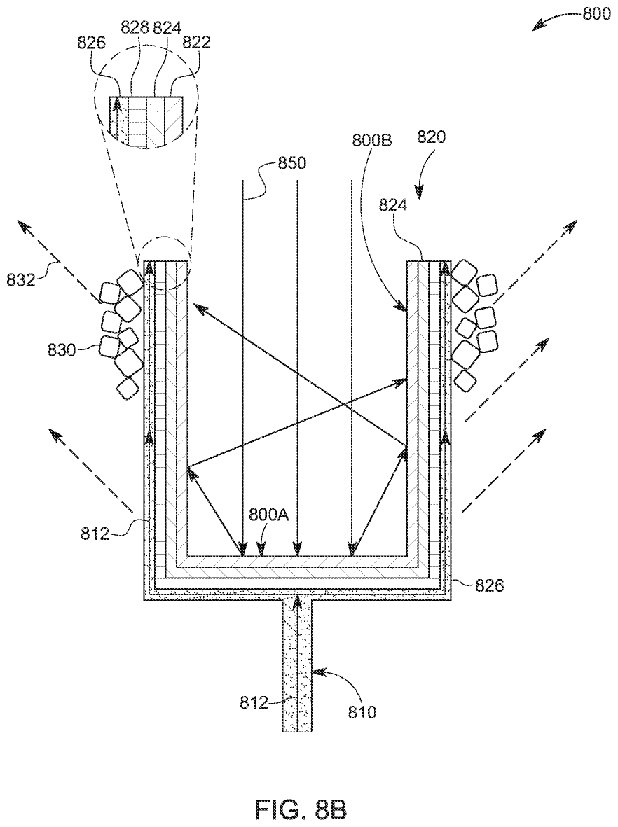

In another embodiment illustrated in FIGS. 8A and 8B, a 3D solar crystallizer system 800 is operated with a dead-end type solar driven water removal mode, in which the water evaporation surface and the light absorption surface are physically separated by a physical barrier, for example, an aluminum sheet, with a high thermal conductivity. The system 800 includes a brine source 802 that includes a brine 804. The system 800 further includes a support module 810 that is attached to an evaporation module 820. The evaporation module 820 may be located on a support 812, which sits on the brine source 802. The support module 810 in this embodiment provides a brine path 812 from the brine source 802 to the evaporation module 820.

The evaporation module 820 is shown in cross-section in FIG. 8B and includes an optional insulation layer 822, a heat source layer 824, and a brine evaporation interface layer 826, formed in this order, similar to the system 100. The bottom and inner walls of the evaporation module 820 act as the sunlight absorbing component with a high light absorptance of 0.99, while its outer wall surface serves as the brine evaporation interface layer and consequently as a salt crystallization surface. Salt crystals 830 are shown being formed on the outside of the evaporation module 820 and the water vapors 832 leaving the wall of the evaporation module 820.

The barrier layer 828 may be placed between the heat source layer 824 and the brine evaporation interface layer 826. In one application, the barrier layer 828 is implemented as a layer of aluminum. The high thermal conductivity of the aluminum separator layer 828 effectively conducts the heat generated at the bottom 800A of the system 800, where most of the incident light waves 850 are striking, to its side wall 800B for enhancing the water evaporation process.

All these features result in an extremely high solar-to-evaporation performance of the system 800. For example, in one testing experiment, the system 800 produced a high water removal performance (1.61 kg m⁻²h⁻¹) under one sun illumination when pure NaCl brine with 24 wt % concentration was used as the source brine. However, when directly treating the concentrated real seawater brines, a quick decline followed by a close to zero water evaporation rate was recorded by the same solar crystallizer, because the magnesium sulfate in the real brines led to the formation of dense scaling salt crust layer that sealed the evaporation surface. When a salt crystallization inhibitor, e.g., nitrilotriacetic acid (NTA), was introduced into the same real seawater source brines to modulate salt crystallization behaviors on the outer surface of the solar crystallizer system 800, it resulted in a dense scaling crust layer-free salt crystallization while treating the real brine. By applying a small amount (only 8.4 wt‰ of the salt) of the salt crystallization inhibitor 806 to the brine 802, which was a highly concentrated real RO waste brine (21.6 wt %), resulted in a very high and stable water evaporation rate of 2.08 kg m−2 h−1 for the 72 h monitored.

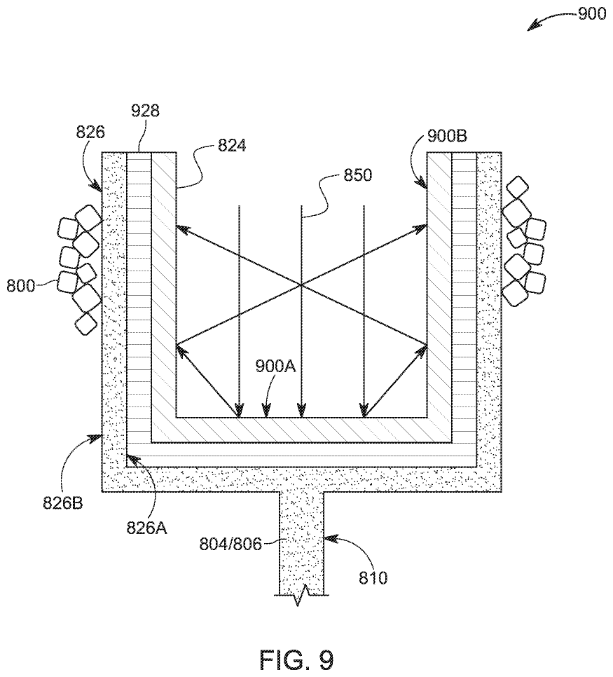

More details about one practical implementation of the crystallizer system 800 used for the above measurements are now discussed with regard to FIG. 9. However, note that the system 800 may be implemented with different configurations. The 3D solar crystallizer 900 is an open box structure with one bottom closed. The bottom 900A and the side wall 900B of the crystallizer system 900 are bi-layered in configuration. The inner layer 824 is a commercially available spectrally selective solar absorber (Alanod®) homogeneously coated on an aluminum sheet 928 and serves as the photothermal component. The outer layer 826 of the solar crystallizer system 900 is a porous and hydrophilic quartz glass fibrous filter membrane (QGF membrane, Merck®). The outer QGF membrane, when wet, is directly stacked onto the backside of the aluminum sheet 928 via capillary force, without any glue. It wicks the brine 804 and the crystal growth inhibitor 806 from the source brine reservoir (not shown) and allows the brine 804 and the crystal growth inhibitor 806 to spread over the entire outer surface 826 during operation. The inner layer 824 of the 3D crystallizer system 900 acts as the light absorbing surface while the outer QGF membrane 826 serves as water transportation and evaporation surface. The aluminum sheet 928 completely separates the two active surfaces and has a desirably high thermal conductivity (˜200 W m−1 K−1), which is beneficial for the heat conduction. The solar crystallizer system 900 is directly placed on top of an expanded polystyrene foam 812 (see FIG. 8) to minimize the heat loss to the bulk brine. The source brine 804 is transported via capillary action, from the reservoir 802 to the solar crystallizer 900, by a one-dimensional (1D) QGF strip 810 placed in the middle of the reservoir 802.

When sunlight 850 is illuminated onto the crystallizer system 900, directly from above, the solar energy is absorbed by the photothermal coating layer 824 (note that in this implementation, the insulation layer 822 is not present) at the bottom 900A of the system to generate heat. As illustrated in FIG. 9, the generated heat is then effectively conducted to the wall 900B of the system 900 owing to the high thermal conductivity of the aluminum sheet 928. This heat thereafter drives the water evaporation and ultimately the precipitation of salts 830 exclusively on the outer wall 826 of the crystallizer system 900.

By design, the 3D solar crystallizer system 900 completely separates (physically) the light absorbing layer 824 from the water evaporation layer 826 and thus, the salt precipitation surface solves the drawback of precipitating salt crystals affecting light absorption otherwise inherent in 2D devices and allows for the two surfaces to be independently optimized.

The 3D solar crystallizer 900 was fabricated to have a tetragonal cup-shaped structure with the bottom side length of about 31 mm. The inner surface of the wall 900B is capable of recycling the diffuse reflection light from the bottom 900A and thus, strengthens the light absorption of the device. Three 3D crystallizer systems 900 with a wall height of 30, 50, and 85 mm respectively have been tested and found to have a solar absorptance of 0.96, 0.98, and 0.99, respectively, which compares favorably against the 0.94 solar absorptance of a flat photothermal 2D sheet with the same composition. The wall height of the crystallizer system 900 was fixed at 85 mm for further measurements.

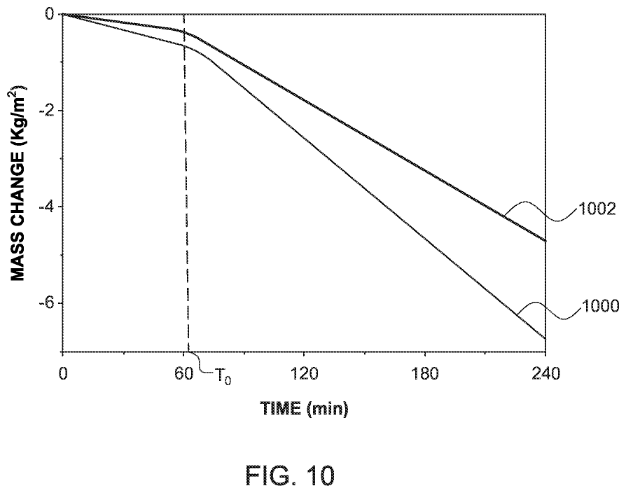

The solar-driven water evaporation performance of the system 900 was evaluated under one-sun illumination. The weight change of the system was recorded in real time as illustrated in FIG. 10, which was then used to calculate the water evaporation rate. FIG. 10 shows that a given time T0, when the light is turned on, the mass of the system decreases as the time passes, indicating the water evaporation. Curve 1000 illustrates the evaporation of distilled water (i.e., no salt present) and curve 1002 illustrates the evaporation for a brine 804 having 24% NaCl without any crystal grown inhibitor 806. The average evaporation rate of pure water under one sun illumination on this 3D crystallizer system 900 reached 2.09 kg m⁻²h⁻¹ with an apparent solar evaporation efficiency of 138.5% and a net solar evaporation efficiency of 94.3%.

When the 3D solar crystallizer system 900 was operated with a 24 wt % pure NaCl brine, a stable high evaporation rate of 1.61 kg m⁻²h⁻¹ was recorded, which stayed steady for at least 24 hours. After 24 hours, a significant amount of salt crystals precipitated on the entire outer wall surface 900B, forming a thick crust layer. The crust layer 830 was composed of rough NaCl crystal balls with diameters in the range of 1.8-8.3 mm. The salt layer possess quite strong mechanical strength and can only be reluctantly scraped off with a stainless steel knife.

The crystallization inhibitors are known to have the capability of effectively controlling the morphology of precipitating salts even at a very small amount. Nitrilotriacetic acid (NTA) was used for the various experiments performed with the system 900, which is an effective salt crystallization inhibitor, is low cost, and has a good biodegradability. In using it, 8.4‰ NTA was added to the concentrated RO waste brine to investigate its effect (8.4‰ being the weight of NTA equal to 8.4‰ of that of the total salts in the brine). With the NTA in the brine, the average water evaporation rate of the concentrated RO waste brine by the 3D solar crystallizer system 900 in the first 24 hours was lifted drastically to 2.08 kg m⁻²h^{31 1}, near 30% higher than the water evaporation rate of 24 wt % pure NaCl brine (1.61 kg m⁻²h⁻¹).

In the 3D crystallizer system 900, heat is conducted from the aluminum sheet 928 surface to the inner side 826A of the QCF membrane 826 first and then further to the outer surface 826B of the QGF membrane 826. In addition, water evaporation is endothermic and an interfacial process, which takes place only at the outer surface 826B of the QGF membrane 826. As a result, the outer surface 826B of the QGF membrane 826 possesses a lower temperature and higher salt concentration than the inner side 826A of the same membrane, leading to a selective precipitation of NaCl salt crystals only on the outer surface 826B. The competitive advantage of the outer surface 826B in salt precipitation keeps the inner side 826A of the membrane 826 free of salt crystals and maintains the water path 812 inside the QGF membrane 826 unobstructed.

The stable solar energy input, highly porous structure of the salt crust layer, and the unobstructed water path inside the QGF membrane all contributed to the stable water evaporation rate of the 3D solar crystallizer system 900 for treating even very highly concentrated NaCl brines. In conventional 2D solar crystallizers, owing to the coincidence of their light absorption and salt precipitation surfaces, they can only produce a small water evaporation rate in treating NaCl brines (e.g., 0.5 kg m⁻²h⁻¹ for 15 wt % NaCl brine.

It is worth noting that the 3D solar crystallizer system 900 exhibited a significantly higher water evaporation rate (i.e., 1.61 kg m⁻²h⁻¹ even for 24 wt % NaCl brine) than the 3D solar device reported by Shi et al. with similar 3D cup-shaped structure (i.e., 1.26 kg m⁻²h⁻¹ for 25 wt % NaCl brine). The higher heat conductivity of the 3D crystallizer system 900 may be the reason that explains this difference. In these two 3D structures, the light directly hits only on the bottom part of the devices and is in-situ converted to heat via photothermal effect. The low thermal conductivity of the device reported by Shi et al. makes its bottom part having a much higher temperature than the wall part, which increases the heat loss via thermal radiation. Further, the 3D crystallizer system 900 showed a relatively uniform temperature distribution under solar radiation and this uniform temperature profile across the wall in the system 900 is believed to lead to its better performance.

After 24-hour operation, a layer of wet and fluffy salt crust layer was formed on the outer wall of the device with NTA in the concentrated RO waste brine, which is quite different from the dense glass-like salt crust layer formed in the absence of NTA. It is noted that there were some salt crystals automatically cleared off the surface by their own gravity during the 24-hour operation. The salt layer could be easily removed from the wall surface by a plastic spatula or by a mild shock impact. SEM observation results show that the salt precipitation did not plug the pores of the QGF membrane in this case.

After the salt crust layer was directly removed by a plastic spatula without any water washing treatment, the 3D solar crystallizer system 900 was able to deliver a similar evaporation performance for the second 24-hour test cycle, indicating that the 3D solar crystallizer system can be easily regenerated and reused without noticeable change in real brine treatment performance. It was also noticed that, when the solar light was turned off during the operation, the evaporation rate dropped to around 0.3 kg m⁻²h⁻¹. However, the surface salt layer did not show any noticeable change even after the solar crystallizer was kept in dark for 12 hours, indicating the re-dissolution of the salt crystals was insignificant.

Upon turning on the light, the evaporation rate was recovered to the same level as the previous. Thus, the 3D solar crystallizer system 900 can operate continuously during day and night without special care while treating the concentrated real RO waste brine, and the solid salts can be regularly removed from the device. All these results demonstrate that by adding NTA in the source brine, this solar crystallizer system delivers a long-term operation stability for highly concentrated real seawater brine without any special device cleaning treatment.

One or more advantages of the systems discussed herein include: (1) the evaporation and crystallization are limited at the air/brine interface; (2) the crystallized salt on the water evaporation interface is allowed to leave the surface on its own gravity, which minimizes human intervention; (3) the salt fouling and scaling are avoided, which ensures the long-term operation of the system, and/or (4) given the loose nature of the surface-water-evaporation-induced salt accumulation, the effect of the surface accumulated salt solid on the surface water evaporation rate is insignificant.

Thus, a system that achieves continuous salt extraction may have a constantly high evaporation performance, extends the operation longevity, reduces the maintenance requirement of the system during applications, all leading to much reduced operational cost for the same level of products delivered.

The continuous salt extraction systems discussed herein may be used with the following emerging applications: (1) Brine treatment; brine disposal is a long-lasting problem in many industrial processes, including seawater desalination, solar distillation, mineral extraction, etc. (2) Salt extraction out of salty water for the purpose of metal salts mining from salt lakes and sea water, and salt resource recovery from industrial wastewaters. (3) Salty wastewater volume reduction. This is a field full of potential, which may represent a future growth point of environment protection and energy management.

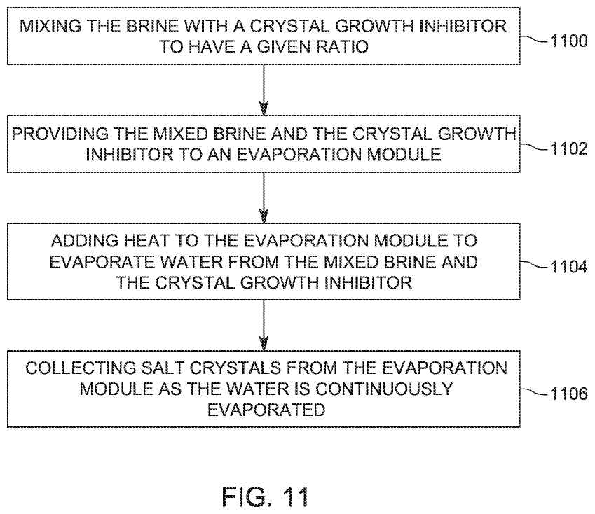

A method for evaporating water from a brine is now discussed with regard to FIG. 11. The method includes a step 1100 of mixing the brine 120 with a crystal growth inhibitor 134 to have a given ratio, a step 1102 of providing the mixed brine 120 and the crystal growth inhibitor 134 into an evaporation module 110, a step 1104 of adding heat to the evaporation module 110 to evaporate water from the mixed brine 120 and the crystal growth inhibitor 134, and a step 1106 of collecting salt crystals 126 from the evaporation module 110 as the water is continuously evaporated. The salt crystals 126 have a modified structure in which ions of the salt crystals were replaced by ions of the crystal growth inhibitor 134. In one application, a support module 102 is attached to the evaporation module 110 and is configured to support the evaporation module 110 above the brine.

The method may also include a step of stirring with a stirring device the brine with the crystal growth inhibitor prior to evaporation, and/or a step of controlling with a processor a concentration of the crystal growth inhibitor in the brine, and/or a step of moving the brine and the crystal growth inhibitor through capillarity to the evaporation module, and/or a step of evaporating the water from the brine at a brine evaporation interface layer, which is part of the evaporation module; transferring heat from a heat source layer to the brine evaporation interface layer for the evaporation process, wherein the heat source layer is part of the evaporation module; and preventing heat, with an insulation layer, from being lost to the environment from the heat source layer, wherein the insulation layer is part of the evaporation module.

The disclosed embodiments provide methods and mechanisms for continuously evaporating water from a brine, with minimum human intervention in terms of cleaning salt particles from the system. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

Shi, Y. et al., “Solar Evaporator with Controlled Salt Precipitation for Zero Liquid Discharge Desalination,” Environ. Sci. Technol. (Oct. 1, 2018).

1. A water evaporation system comprising:
an evaporation module configured to evaporate water from a brine;
a support module attached to the evaporation module and configured to support the evaporation module above the brine; and
an inlet configured to add a crystal growth inhibitor to the brine.

2. The system of claim 1, further comprising:
a brine container for holding the brine,
wherein the support module has a first end located into the brine.

3. The system of claim 2, wherein the first end is attached to the brine container.

4. The system of claim 2, wherein the inlet is configured to release the crystal growth inhibitor into the brine container.

5. The system of claim 2, further comprising:
a stirring device configured to stir the brine with the crystal growth inhibitor within the brine container.

6. The system of claim 5, further comprising:
a pump that pumps the crystal growth inhibitor to the inlet.

7. The system of claim 6, further comprising:
a processor attached to the pump and to a brine concentration sensor,
wherein the processor is configured to start and stop the pump and the stirring device to continuously mix the brine with the crystal growth inhibitor.

8. The system of claim 1, wherein the support module includes a porous material that makes the brine to move up to the evaporation module.

9. The system of claim 1, wherein the evaporation module comprises:
a brine evaporation interface layer;
a heat source layer; and
an insulation layer,
wherein water is evaporated from the brine at the brine evaporation interface layer,
wherein the heat source layer transfers heat to the brine evaporation interface layer for the evaporation process, and
wherein the insulation layer prevents the heat from the heat source layer to be transferred to the environment.

10. The system of claim 9, wherein the heat source layer includes a Joule heater, or a pipe that receive a hot fluid, or a combustion chamber.

11. The system of claim 1, wherein the evaporation module has a T-shaped cross section.

12. A method for evaporating water from a brine, the method comprising:
mixing the brine with a crystal growth inhibitor to have a given ratio;
providing the mixed brine and the crystal growth inhibitor to an evaporation module;
adding heat to the evaporation module to evaporate water from the mixed brine and the crystal growth inhibitor; and
collecting salt crystals from the evaporation module as the water is continuously evaporated,
wherein the salt crystals have a modified structure in which ions of the salt crystals were replaced by ions of the crystal growth inhibitor.

13. The method of claim 12, wherein a support module is attached to the evaporation module and is configured to support the evaporation module above the brine.

14. The method of claim 12, further comprising:
stirring with a stirring device the brine with the crystal growth inhibitor prior to evaporation.

15. The method of claim 14, further comprising:
controlling with a processor a concentration of the crystal growth inhibitor in the brine.

16. The method of claim 12, further comprising:
moving the brine and the crystal growth inhibitor through capillarity to the evaporation module.

17. The method of claim 12, further comprising:
evaporating the water from the brine at a brine evaporation interface layer, which is part of the evaporation module;
transferring heat from a heat source layer to the brine evaporation interface layer for the evaporation process, wherein the heat source layer is part of the evaporation module; and
preventing heat, with an insulation layer, from being wasted to the environment from the heat source layer, wherein the insulation layer is part of the evaporation module.

18. The method of claim 17, wherein the heat source layer includes a Joule heater, or a pipe that receives a hot fluid, or a combustion chamber.

19. The method of claim 12, wherein the evaporation module has a T-shaped cross section.

20. A water evaporation system comprising:
a heat source layer configured to receive solar energy;
a brine evaporation interface layer configured to receive a mixture of a brine and a crystal growth inhibitor from which to evaporate water; and
a barrier layer located between the heat source layer and the brine evaporation interface layer so that no salt from the brine contaminates the heat source layer.
